(19) United States
(12) Patent Application Publication
(10) Pub. No.: US 2015/0177013 A1
(43) Pub. Date: Jun. 25, 2015

(54) SYSTEM AND METHOD FOR DETERMINING A MODE OF TRAVEL

(71) Applicants: Michael Siliski, San Francisco, CA (US); Joseph Hughes, London (GB); Andrey Yuryevich Ulanov, Seattle, WA (US)

(72) Inventors: Michael Siliski, San Francisco, CA (US); Joseph Hughes, London (GB); Andrey Yuryevich Ulanov, Seattle, WA (US)

(73) Assignee: GOOGLE INC., Mountain View, CA (US)

(21) Appl. No.: 13/275,578

(22) Filed: Oct. 18, 2011

(51) Int. Cl. G01C 21/34; G01C 21/20; G01C 21/36

(52) U.S. Cl. CPC G01C 21/3423; G01C 21/20; G01C 21/3407

(57) ABSTRACT

Methods and systems for determining a mode of travel are described herein. Aspects of the disclosure allow a client device to determine a current mode of travel, and to configure the client device in an optimal manner for providing location-based services, such as route-finding, based on the determined method of travel. The client device is configured using the mode of travel, where a set of configuration options associated with each particular mode of travel. Aspects of the system and method may dynamically determine the mode of travel using sensor data received via the client device.

### BACKGROUND

Technology has advanced to the point where it is common for consumer electronics, such as cellular phones, personal digital assistants (PDAs), laptops, personal computers tablet computers, and the like to have software and/or hardware capable of identifying the location of the device. One common use of this location information is to provide route-finding assistance and other location-based services to the user. By identifying the location of a user and a destination location, the device can direct the user along the most efficient route to the destination.

Many of these client devices are sophisticated enough to provide different routing directions based upon the mode of travel of the user. By manually selecting a mode of travel, the user may prompt the client device to give directions for walking, driving, or taking mass transit. This may result in different optimal routes being displayed to the user, as, for example, the most efficient walking route may differ greatly from the most efficient driving route. Different methods of travel may also necessitate different interfaces with the client device. For example, a user may not wish to hold the client device while on a walking route, so the device may opt to inform the user of direction based on tactile prompts, such as by vibration that can be felt from within the user's pocket. However, these methods of configuring the client device based on mode of travel rely on the user manually specifying a travel mode.

### BRIEF SUMMARY

Methods and systems for determining a mode of travel are described herein. Aspects of the disclosure allow a client device to determine a current mode of travel of a user, and to configure the client device in an optimal manner for providing location-based services, such as route-finding, based on the determined method of travel. The client device is configured using the mode of travel, where a set of configuration options are associated with each particular mode of travel. For example, the client device may perform route finding operations in accordance with the determined mode of travel, such as providing walking directions when the client device has identified that the user is walking. The client device may also configure other device settings based on the mode of travel, such as by setting a display to “sleep” mode and providing routing directions using tactile prompts in a walking mode, or by determining a user location more frequently and providing less detailed maps when in driving mode. Aspects may dynamically determine the mode of travel using sensor data received via the client device.

An aspect of the disclosure provides a computer-implemented method for determining a mode of travel of a client device. The method includes receiving sensor input from one or more sensors of the client device, comparing, using a processor, the sensor input to a set of travel mode data, the travel mode data comprising a plurality of travel modes, one or more criteria for at least one of the plurality of travel modes, and a set of configuration settings associated with the at the least one of the plurality of travel modes for providing location-based services using the client device, selecting a likely travel mode from the set of travel mode data by matching the sensor input with the criteria for the at least one of the plurality of travel modes and identifying a travel mode that most highly correlates the criteria with the sensor input, and configuring the client device using the set of configuration settings associated with the selected likely travel mode. The sensor input may include a geographic position of the client device as determined by a geographic positioning element, and the method may further include identifying a type of route upon which the client device is traveling by comparing the geographic position with a set of map data, and selecting the likely travel route by comparing the type of route with the criteria for the at least one of the plurality of travel modes.

The set of configuration settings may include at least one of display settings, navigation prompt settings, and map detail settings. The plurality of travel modes may include at least one of a walking travel mode, a driving travel mode, an air travel mode, a bicycling travel mode, and a mass transit travel mode. The client device may be configured to perform route-finding operations. The route-finding operations may identify a travel route via the likely travel mode. The one or more criteria for the at least one of the plurality of travel modes may include a set of types of routes upon which the user has an option to travel when engaged in the travel mode. The walking travel mode may be associated with at least one of a sidewalk, a crosswalk, and a walking path. A driving travel mode may be associated with at least one of a city street, a county road, and a highway. A mass transit travel mode may be associated with at least one of a subway, a bus route, and a train route. The one or more criteria for the mass transit travel mode may include a velocity threshold associated with one or more mass transit stops. The method may further include identifying when the client device passes a transition point where a user has an option to transition from a first travel mode to a second travel mode, and determining the travel mode of the client device in response to the client device passing the transition point. The one or more transition points may be defined in a set of map data. The set of map data may be received from a remote server. The method may also include sending the sensor input to a remote server, and sending the likely travel mode to the client device from the remote server.

Another aspect of the disclosure provides a processing system for determining a mode of travel. The processing system may include a processor, one or more sensors coupled to the processor, and a memory coupled to the processor for storing a set of travel mode data, the travel mode data comprising a plurality of travel modes, one or more criteria for at least one of the plurality of travel modes, and a set of configuration settings associated with the at least one of the plurality of travel modes for providing location-based services using the client device. The processor may be configured to receive sensor input from the one or more sensors, to compare the sensor input to the one or more criteria, to select a likely mode of travel based on the comparison of the sensor input to the criteria, and to configure the processing system in accordance with the selected likely mode of travel. The memory may further include a set of map data that associates a plurality of locations with one or more types of routes. The one or more criteria may specify one or more types of routes that each travel mode may utilize. The processor may be further configured to identify a location of the client device, identify a type of route upon which the client is present using the location and the map data, and to filter the plurality of travel modes by the type of route upon which the client device is present.

Another aspect of the disclosure may provide a non-transitory computer readable storage medium containing instructions that, when executed by a processor, cause the processor to perform a method. The method may include receiving sensor input from one or more sensors, comparing, using a processor, the sensor input to a set of travel mode data, the travel mode data comprising a plurality of travel modes, one or more criteria for at least one of the plurality of travel modes, and a set of configuration settings associated with the at least one of the plurality of travel modes for providing location-based services using the client device, selecting a likely travel mode from the set of travel mode data by matching the sensor input with the criteria from each travel mode and identifying a travel mode that best matches the criteria with the sensor input, and configuring a client device using the set of configuration settings associated with the selected likely travel mode. The sensor input may further include a geographic position of the client device as determined by a geographic positioning element and the method may further include identifying a type of route upon which the client device is traveling by comparing the geographic position with a set of map data, and selecting the likely travel route by comparing the type of route with the criteria for each travel mode. The set of configuration settings may include at least one of display settings, navigation prompt settings, and map detail settings. The plurality of travel modes may include at least one of a walking travel mode, a driving travel mode, an air travel mode, and a mass transit travel mode.

### BRIEF DESCRIPTION OF THE DRAWINGS

FIG. 1 is a system diagram depicting an example of a server in communication with an example of a client device in accordance with aspects of the disclosure.

FIG. 2 is diagram depicting an example map 200 demonstrating a process for determining a mode of travel in accordance with aspects of the disclosure.

FIG. 3 is a flow diagram depicting an example of a method for providing routing operations while configured by a determined mode of travel in accordance with aspects of the disclosure.

FIG. 4 is a flow diagram depicting an example of a method for determining a mode of travel in accordance with aspects of the disclosure.

### DETAILED DESCRIPTION

Aspects of the disclosure provide for a system and method that determine a mode of travel. The mode of travel is used to determine a set of configuration details of the client device to facilitate the operation of a location based services module. The configuration details are associated with the particular mode of transportation, such as walking, driving, bicycling, or mass transit. The mode of travel may be determined by examining input from one or more device sensors, and comparing the input to a set of criteria used to define the modes of travel. The client device identifies the most likely mode of travel using the sensor input, and configures the device accordingly.

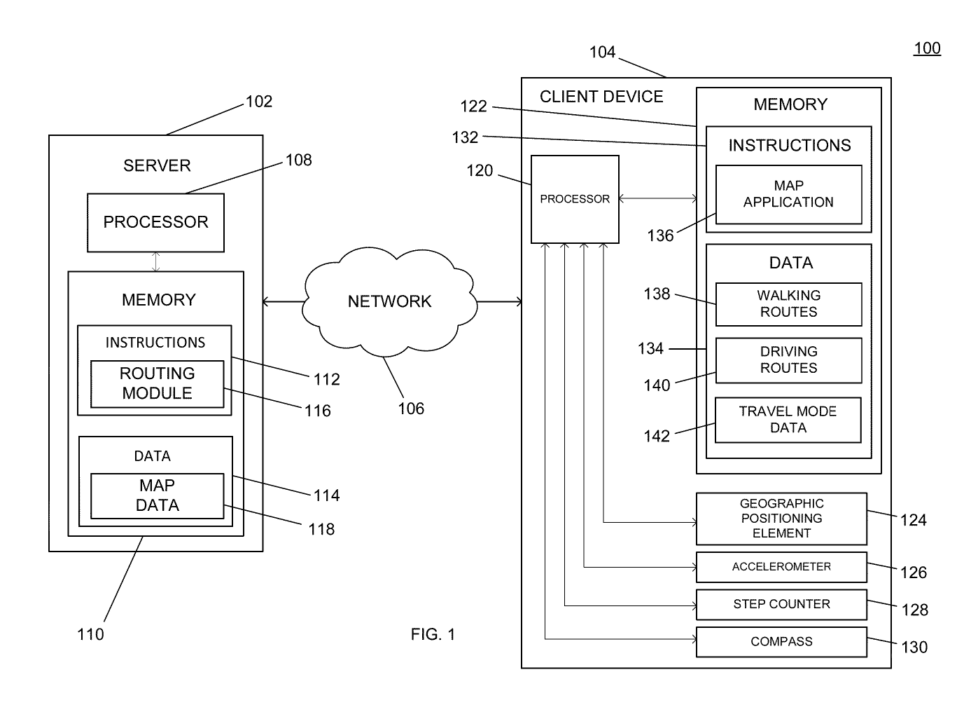

As shown in FIG. 1, a system 100 in accordance with one aspect of the disclosure includes a server 102 in communication with a client device 104 via a network 106. The client device 104 may be any device capable of providing location based services to a user. For example, the client device 104 may be a smartphone, a personal digital assistant (PDA), a handheld GPS receiver, a tablet computer, or the like. In operation, the client device 104 may receive location and/or routing data from the server 102.

The remote server 102 may include a processor 108, memory 110 and other components typically present in general purpose computers. Memory 110 may store information that is accessible by the processor 108, including instructions 112 that may be executed by the processor 108, and data 114. The memory 110 may be of any type of memory operative to store information accessible by the processor 108, including a computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The system and method may include different combinations of the foregoing, whereby different portions of the instructions and data are stored on different types of media.

The instructions 112 may be any set of instructions to be executed directly (such as machine code) or indirectly (such as scripts) by the processor 108. For example, the instructions 112 may be stored as computer code on the computer-readable medium. In that regard, the terms “instructions” and “programs” may be used interchangeably herein. The instructions 112 may be stored in object code format for direct processing by the processor 108, or in any other computer language including scripts or collections of independent source code modules that are interpreted on demand or compiled in advance.

In some aspects, the instructions 112 may comprise a routing module 116. The routing module 116 is operable to provide information to the client device 104 to enable the client device to display a route from the client device location to a destination. In some aspects, the routing module 116 determines a route for the client device 104 and transmits the route for display by the client device 104. For instance, the routing module 116 may transmit a road graph, map tile data, or other map data to the client device 104 and the client device 104 determines a route to the destination based on the transmitted map data. The routing module 116 may receive a mode of travel from the client device 104, and provide routing instructions in accordance with the received mode of travel. Although aspects of the system and method are described with respect to providing routing directions, aspects that provide for determination of a mode of travel are also broadly applicable to other applications that provide location based services, such as location aware business listing directories, location based advertising, location reporting, and any other application for which a user may wish to identify a mode of travel.

Data 114 may be retrieved, stored or modified by the processor 108 in accordance with the instructions 112. For instance, although the architecture is not limited by any particular data structure, the data may be stored in computer registers, in a relational database as a table having a plurality of different fields and records, Extensible Markup Language (“XML”) documents or flat files. The data may also be formatted in any computer readable format such as, but not limited to, binary values or Unicode. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

Portions of the data 114 may comprise map data 118. At least a portion of the map data 118 may be transmitted to the client device 104. For example, the server 102 may store map tiles, where each tile is a map image of a particular geographic area. A single tile may cover an entire region such as a state in relatively little detail and another tile may cover just a few streets in high detail. In that regard, a single geographic point may be associated with multiple tiles, and a tile may be selected for transmission based on the desired level of zoom. The map data 118 may also comprise a road graph or other data suitable for use by the routing module 116 or client device 104 to determine a route from a start location to a destination.

The map information is not limited to any particular format. For example, the images may comprise street maps, satellite images, or a combination of these, and may be stored as vectors (particularly with respect to street maps) or bitmaps (particularly with respect to satellite images).

The various map tiles may each be associated with geographical locations, such that the server 102 is operative to select, retrieve and transmit one or more tiles in response to receiving a geographical location. In some embodiments, the client device 104 may pre-cache and/or store the map information without the need to request map information from the server 102.

The processor 108 may be any suitable processor such as a CPU for execution of computer code. Alternatively, the processor may be a dedicated controller such as an application-specific integrated circuit (“ASIC”).

Although FIG. 1 functionally illustrates the processor and memory as being within the same block, it will be understood by those of ordinary skill in the art that the processor 108 and memory 110 may actually comprise multiple processors and memories that may or may not be stored within the same physical housing. Accordingly, references to a processor, computer or memory will be understood to include references to a collection of processors, computers or memories that may or may not operate in parallel.

The server 102 may be at one node of a network 106 and be operative to directly and/or indirectly communicate with other nodes of the network. For example, the server 102 may comprise a web server that is operative to communicate with the client device 104 via the network 106 such that the server 102 uses the network 106 to transmit and display information to a user via the client device 102. The server 102 may also comprise a plurality of computers that exchange information with different nodes of a network for the purpose of receiving, processing and transmitting data to the client devices; in this instance, the client device 104 may be at a different node of the network than any of the computers comprising the server 102.

The network 106, and the intervening nodes between the server 102 and the client device 104, may comprise various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, hypertext transfer protocol (“HTTP”) and simple mail transfer protocol (“SMTP”), and various combinations of the foregoing. Although only a few devices are depicted in FIGS. 1, it should be appreciated that a typical system may include a large number of connected computers.

The client device 104 may be configured similarly to the server 102, with a processor 120 and memory 122. As described with respect to the server 102, the memory 122 may comprise a set of instructions 132 and a set of data 134. The processor 120 executes the instructions 132 to control operation of the client device 102. In some aspects, the client device 104 may be a mobile phone operative to wirelessly exchange data with a server over a network such as the Internet. The instructions 132 may include a map application 136. The map application 136 provides an interface for the user to receive routing instructions. For example, the map application 136 may identify a user location, allow the user to input a destination, and display a route from the user location to the destination. The map application 136 may determine the route, or the map application 136 may interface with a server, such as the server 102, to send location and/or destination data and receive a route for display to the user. As described above, although aspects of the system and method are described with respect to a map application 136, the same and similar concepts are also applicable to other location-aware applications and location-based services application that may execute on the client device 104 and the server 102.

Regardless of how location data is obtained, appropriate efforts can be taken to protect user privacy. For example, collection of location data may be on an opt-in basis so that data is not collected or used unless the user has been informed of the collection and planned use of location data and provided permission for such collection and use to occur, with the location data stored and handled in a secure manner.

The data 134 may comprise a set of walking routes 138, a set of driving routes 140, and a set of travel mode criteria 142. The walking routes 138 and the driving routes 140 identify routes by which a user may travel according to the designated mode of travel. For example, the walking routes 138 may include walking paths such as sidewalks, crosswalks, walking paths, or any other area where a user may walk from one destination to another. The driving routes 140 may include roads, parking lots, driveways, highways, or any other path upon which the user may drive a vehicle. The walking and driving routes as described are not intended to be limiting, and any number of different routes may be associated with other methods of travel, such as via boat/ship, bicycle, mass transit, plane, or any other mode of travel. Routes may also be provided for a subset of routes for a given mode of travel, such as only highways or toll roads as a subset of set of driving routes 140.

The travel mode data 142 provides a set of criteria for determining the travel mode of the client device 104 and a set of configuration settings associated with each travel mode. These criteria may relate to characteristics of each mode of travel. For example, the travel mode data 142 may be in the form of a data table such as the following:

TABLE 1

| Travel | | | | Configuration |
|---|---|---|---|---|
| Mode | Velocity | | Road Graph | Settings |
| Walking | 0-6 | mph | Sidewalk, path, | Place display into sleep |
| | | | crosswalk, | mode, enable vibration |
| | | | inside a | based navigation prompts, |
| | | | building | enable enhanced detail |
| | | | | maps |
| Driving | 0-100 | mph | Street, highway, | Activate display, enable |
| | | | tunnel, parking | audio prompts, enable |
| | | | lot | reduced detail maps |
| Bicycling | 10-20 | mph | Bicycle lane, | Activate display, enable |
| | | | sidewalk, | enhanced detail maps |
| | | | bicycle trail | |

As can be seen from the table above, each mode of travel may be associated with one or more criteria and a set of configuration settings. The particular criteria displayed in Table 1 are a velocity and a location within a road graph. For example, if a user is traveling at 55 mph and located in an area designated as a highway on the road graph, it is likely that the user is driving. Other possible criteria may include analysis of a location history of the user.

For example, a user may be identified as driving, and then enter a parking lot. Upon entering the parking lot, the user may be identified as walking. When the user returns to the parking lot, the user is likely to return to a driving state when they return to their vehicle. Other criteria may include the use of particular transition points. For example, the criteria may indicate that a user is likely to be entering a “mass transit” mode of travel upon entering a bus terminal or train station. Various other criteria may also be employed. For example, traveling the wrong way down a one-way street may be indicative that the user is walking, or inconsistent direction and/or zigzagging may be a sign of walking rather than driving (e.g., greater than a threshold number of direction changes are identified by the mobile device over a given time period). Frequently slowing down or stopping at known mass transit stops may be indicative that the user is traveling via a particular mode of mass transit (e.g., a bus or train slowing down or stopping at known bus stops or train stations, respectively).

Although in the present example each travel mode is associated with selection criteria, one or more travel modes may not be associated with any criteria. For example, a particular travel mode may be a “default” state represented by an absence of selection criteria. In such an example, this particular travel mode might be enabled when the sensor data does not correspond to the criteria of any travel mode with specified criteria. As another example, a set of travel mode data may describe a plurality of modes of travel, of which some modes of travel are dynamically configurable based on criteria, and of which other travel modes are manually selectable by a user.

The client device 104 may have all of the components normally used in connection with a wireless mobile device such as a central processing unit (CPU), memory (e.g., RAM and ROM) storing data and instructions, an electronic display 162 (e.g., a liquid crystal display (“LCD”) screen or touch-screen), user input (e.g., a keyboard, touch-screen or microphone), camera, a speaker, a network interface component, and all of the components used for connecting these elements to one another. Some or all of these components may all be internally stored within the same housing, e.g. a housing defined by a plastic shell and LCD screen.

The client device 104 may also include a geographic positioning element 124, such as circuits, to determine the geographic location and orientation of the device. For example, client device 104 may include a Global Positioning System (“GPS”) receiver that may determine the latitude, longitude and altitude of the client device 104. The geographic positioning element 124 may also comprise software operative to determine the position of the device based on other signals received at the client device 104. As specific, non-limiting examples, these other signals may comprise signals received from one or more cell phone towers where the client device 104 includes a cell phone, signals received from local Wi-Fi access points, and the like.

In some aspects, the client device 104 may also include an accelerometer 126 and/or gyroscope (not shown) to determine the orientation of the device. By way of example only, the client device 104 may determine its pitch, yaw or roll (or changes thereto) relative to the direction of gravity or a plane perpendicular thereto.

The client device 104 may comprise a step counter 128. The step counter 128 may operate in conjunction with the accelerometer 126 to identify when the user takes a step. For example, the step counter 128 may identify user walking motions by using one or more accelerometers to measure impact that is consistent with footfalls and/or movement at a walking speed in a particular direction.

The client device 104 may further comprise a compass 130. The compass 130 may provide a bearing by employing one or more sensors to measure a magnetic field. For example, the compass may output either a digital or analog signal proportional to its orientation. The signal may be read by a controller or microprocessor to interpret the bearing of the client device 104. In some aspects, the compass 130 may be a gyroscopic compass, or a traditional “needle” compass. Any compass capable of providing bearing information would be suitable for aspects of the disclosure.

The compass 130 may further interface with the accelerometer 126 to determine a bearing for the client device 104. For example, the compass 130 and the accelerometer 126 may send data to the processor 108. The processor 108 may calibrate the readings from the compass 130 based on orientation data received from the accelerometer 126. For example, a user may not hold the client device 104 upright while traveling. Thus the compass 130 may not be able to accurately determine a direction, because the client device 104 is not held upright in relation to the user's direction of travel. As such, a reading from the accelerometer may allow the client device 104 to determine the orientation of the device relative to the user. For example, if the user places the client device 104 upside down in their pocket, the accelerometer 126 would detect that the device is inverted and thus reverse the bearing identified by the compass 130. The accelerometer 126 may also be used in combination with the compass 130 to obtain a more accurate reading even when the device is in normal orientation. For example, data received from the accelerometer 126 may be used to cancel out movements of the device when obtaining a reading from the compass 130.

Although the client device 104 may comprise a mobile phone, the client device 104 may also comprise a personal computer, personal digital assistant (“PDA”), tablet PC, netbook, etc. In this regard, the client device 104 may have a display comprising a monitor having a screen, a projector, a television, a computer printer or any other electrical device that is operable to display information. The client device 104 may accept user input via other components such as a mouse. Indeed, devices in accordance with the systems and methods described herein may comprise any device operative to process instructions and transmit data to and from humans and other computers including general purpose computers, network computers lacking local storage capability, etc.

Although certain advantages are obtained when information is transmitted or received as noted above, other aspects of the system and method are not limited to any particular manner of transmission of information. For example, in some aspects, information may be sent via a medium such as an optical disk or portable drive. In other aspects, the information may be transmitted in a non-electronic format and manually entered into the system.

Although some functions are indicated as taking place on the server 102 and other functions are indicated as taking place on the client device 104, various aspects may be implemented by a single computer having a single processor. In accordance with the aspects of the system and method, operations performed on the client may be implemented on the server, and vice-versa.

The system and method may process locations expressed in different ways, such as latitude/longitude positions, street addresses, street intersections, an x-y coordinate with respect to the edges of a map (such as a pixel position when a user clicks on a map), names of buildings and landmarks, and other information in other reference systems that is operative to identify a geographic locations (e.g., lot and block numbers on survey maps). Moreover, a location may define a range of the foregoing.

The system and method may further translate locations from one reference system to another. For example, the server 102 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)). In that regard, it will be understood that exchanging or processing locations expressed in one reference system, such as street addresses, may also be received or processed in other references systems as well.

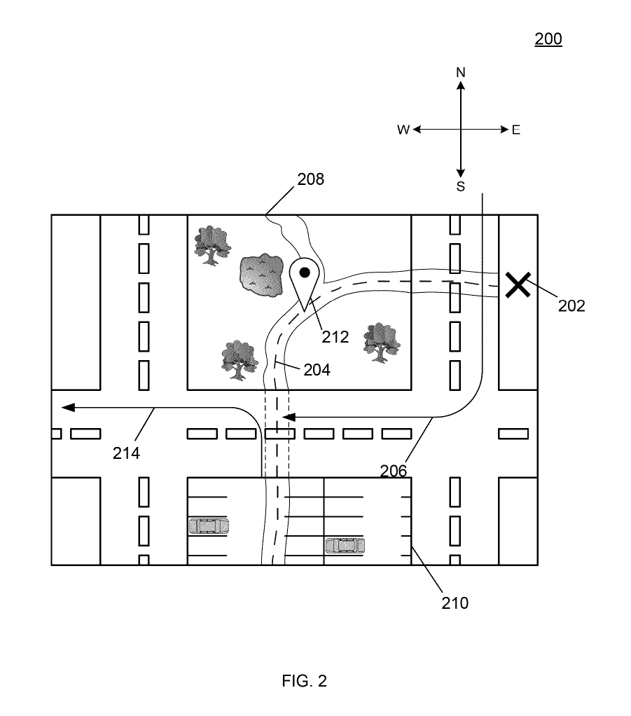

FIG. 2 is diagram depicting an example map 200 demonstrating a process for determining a mode of travel in accordance with aspects of the disclosure. The map 200 depicts an initial client device location at point 202. At this initial location, it is unclear how best to provide a route to the client device. If the user is walking, then the walking route 204 through the nearby park 208 is optimal, due to the fact that the path is a foot path and does not require travel on the nearby roads. If the user is driving, then the driving route 206 along the road is most efficient, since a vehicle cannot travel through the park 208, and there are no safety concerns with driving on a road as there would be for walking in an area reserved for vehicles.

In order to perform the determination for which route to take, aspects of the system and method may analyze a client device position along with map data, such as a road graph. The present illustration shows a park 208 surrounded by a series of roads, and across from a parking lot 210. These various elements of the road graph may be associated with particular methods of travel, or other data which may indicate particular attributes of locations described in the map data. For example, various streets, walking paths, or bicycle lanes may be identified as such, streets with sidewalks may be identified as appropriate for both driving and walking, or other data associated with map locations may be used to identify appropriate modes of travel. In some aspects, the client device 104 may maintain different sets of routes for different modes of travel, as described above with respect to FIG. 1.

In the present map, the user may elect to travel via the park 208. As such, the location for the client device may be identified at the point 212, on the walking path 204 within the park. If the client device is identified at point 212, then aspects of the system may identify the user as traveling by walking, as vehicles are not allowed on walking paths in parks.

The map data may include various transitional points where a user is likely to change their mode of travel. In the present example, as the client device continues along the walking path 204, they eventually enter the parking lot 210. The parking lot 210 may be identified as a transitional area in the map data, as the user may choose to enter their vehicle and begin driving. In the present map, the user may elect to leave the parking lot via the driving path 214 after following the walking path 204.

Aspects of the system and method may identify such transitional points as areas that the client device is likely to change the mode of travel. Transitional points may include parking lots as described above, or mass transit hubs (e.g., bus terminals, train stations, subway stations), airports, or other locations at which users customarily change their method of travel. Such areas may be marked in the map data and used to determine the current method of travel. For example, a client device is more likely to transition from a walking mode of travel to a mass transit mode of travel at a subway station than to a driving mode of travel. These transition points may be identified within the travel mode data 142 (e.g., this mode of travel may be likely to begin at this type of location), or within map data describing the locations (e.g., users typically enter this mode of travel at this particular location), or some combination of the two methods.

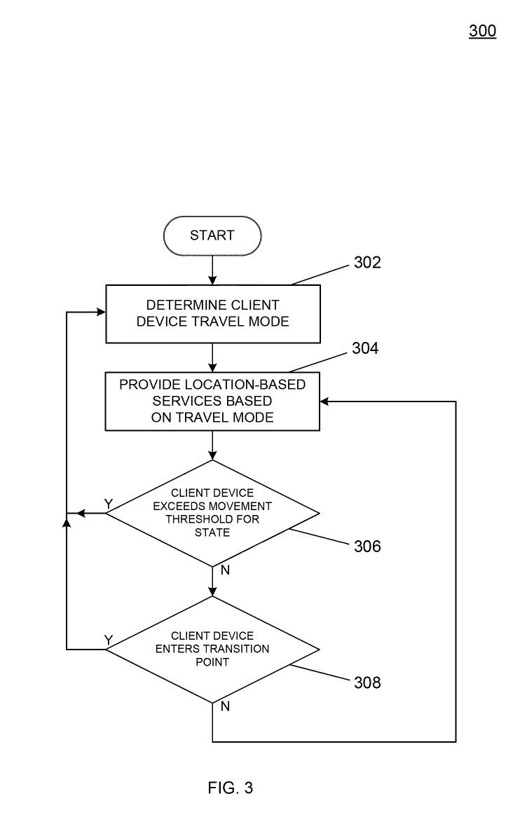

FIG. 3 is a flow diagram depicting an example of a method 300 for providing routing operations while configured by a determined device state in accordance with aspects of the disclosure. The method 300 allows for the dynamic determination of a mode of travel of a client device, and configuration of the client device in accordance with the determined mode of travel. In this manner the method ensures that the client device is optimally configured to provide location-based services to the user. For example, the client device may provide travel-mode specific routing instructions, or optimize the method by which routing instructions are relayed based on the determined method of travel.

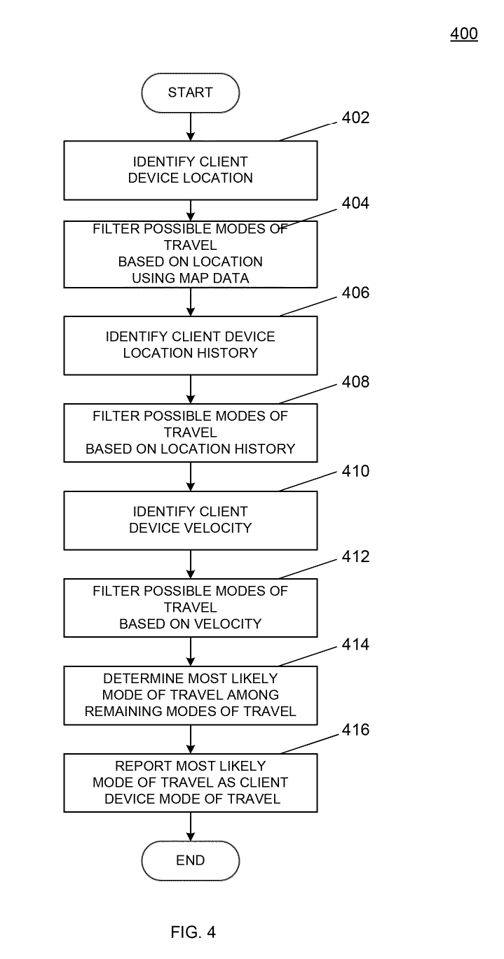

At stage 302, a travel mode of the client device is determined. The travel mode may be determined by comparing sensor data received from various client device sensors with a set of travel mode data. The travel mode data specifies various criteria associated with each travel mode that may be used to determine the most likely mode of travel. A method for determining a likely mode of travel is described below (see FIG. 4). The determination of the mode of travel may also result in the alteration of various client device configuration settings.

At stage 304, the client device is configured to provide location-based services in accordance with the determined travel mode. Various aspects of the client device may be configured based on the travel mode. For example, vibration based navigation indicators may be enabled in a walking mode (e.g., the client device vibrates once for an upcoming left turn, or twice for an upcoming right turn), and the display may be put to sleep to conserve battery power. Such configuration settings may be preferable because users typically do not hold the client device in front of them when using the client device for route finding; the client device may typically be stored in a pocket. If the client device is identified as in driving mode, the device may be configured to display less detailed maps, focusing on streets and roads. Various other configuration options may be employed to optimize location-based services for different modes of travel.

The client device may also perform routing operations based on the travel mode. Certain routes may only be available when traveling in a certain manner. For example, walking paths are typically closed off to cars and other vehicles, while pedestrians are not allowed on highways. As such, the client device would route a walking user along routes that allow pedestrians, a driving user along routes that allow vehicles, and in a corresponding manner for other forms of transportation (buses, taxis, planes, trains, subways, etc.).

At stage 306, a determination is performed as to whether the client device has left the criteria of the mode of travel determined at stage 302. The modes of travel are typically associated with certain criteria. These criteria can be used to both determine the initial mode of travel and to monitor for when the user has likely changed their mode of travel. For example, a walking mode of travel may be typically associated with travel at less than 5 mph, 10 mph, or some other number. If the client device determines that the user is traveling at a velocity in excess of a typical walking speed, such as greater than 10 mph, 25 mph, or 55 mph, then it is likely the user is no longer walking, and the method should attempt to redetermine the mode of travel. Various other thresholds may be used to determine whether the user has altered their form of travel, such as their position on the road graph (e.g., the user's presence on a walking path is likely indicative they are no longer driving a vehicle).

At stage 308, a determination is performed as to whether the user has passed through a transition point. A transition point may be any location where users typically transition to a new mode of travel. For example, bus terminals, parking lots, train stations, and airports may be considered transition points as users typically alter their mode of travel at these locations. As such, when the user passes through one of these areas, it may be appropriate to attempt to redetermine the mode of travel of the user.

FIG. 4 is a flow diagram depicting an example of a method 400 for determining a mode of travel in accordance with aspects of the disclosure. The method 400 is operable to receive input from various sensors associated with the client device, such as the geographic positioning element 124, the accelerometer 126, the step-counter 128, and/or the compass 130. The input is used to identify a device location, velocity, and location history, which are used to filter travel modes from a set of travel modes. The method 400 attempts to eliminate possible travel modes until only a single travel mode remains, which is then reported as the travel mode of the client device. In circumstances where more than one travel mode remains, the method 400 may identify a most likely travel mode as the travel mode of the client device. For example, the client device may be configured to operate in travel modes corresponding to travel on foot, in a car, and via a train.

At stage 402, the location of the client device is identified. The location may be identified in a variety of manners, such as using the geographic positioning element 124, identification of a nearby wireless access point, or cellular tower triangulation. The greater the precision with which the client device location may be determined, the more likely that particular modes of travel may be eliminated.

At stage 404, the possible modes of travel are filtered based upon the location, using a set of map data. A given set of map data may provide a road graph. For example, the user's location as plotted on the road graph may indicate that the user is on a road that contains a sidewalk. As such, modes of travel that do not permit travel via a road with a sidewalk, such as travel via a train, would be filtered out. Foot travel and car travel would not be filtered, as both modes of travel allow for travel along a road with a sidewalk.

At stage 406, recent location history of the client device is determined. For example, the client device may save recent user locations at a particular interval to identify a location history. The location history may then be used to determine the appropriate mode of travel, as user is unlike to change their mode of travel without passing through some kind of transition point, such as a parking lot, bus terminal, airport, train station, or the like.

At stage 408, the remaining possible modes of travel are filtered based on the recent location. For example, if the user has recently traveled through a park on a walking path to reach the location on the street identified at stage 402, then it is likely that the user is still traveling via walking, and other modes of travel can be filtered out. Similar logic applies to other modes of transportation, as users typically must enter a transition point of some kind prior to changing their mode of travel. If the possible mode of travel cannot be identified after filtering by location history, then the process continues using alternate sensor data.

At stage 410, the velocity of the client device is identified. The velocity may be identified using one or more accelerometers, gyroscopes, global positioning system readings, or any other method of identifying the velocity of the client device.

At stage 412, the remaining possible modes of travel are filtered using the velocity of the client device. Each mode of travel is typically associated with a range of speeds. For example, a walking mode of travel may be associated with a range of 0-6 mph, a driving mode of travel may be associated with 0-100 mph, and a train mode of travel may be associated with 20-60 mph. Thus, the speed of the client device may be used to filter out modes of travel.

At stage 414, the most likely mode of travel is determined. In many cases, only one mode of travel may remain after performing the filtering operations described above. If more than one mode of travel remains, then the most likely mode of travel is determined using an aggregate of the sensor data received via the client device. The sensor data may be used to determine probabilities that the user is in each mode of travel. For example, the user might be 80% likely to be walking, 15% likely to be driving, and 5% likely to be riding a bus. In such a case, the method of travel might be identified as walking. Various thresholds may be employed to determine how to choose a mode from these probabilities and when to switch. For example, the threshold might be 50%, 75%, or 90% likely before switching to the particular mode of travel.

Although various methods of filtering are described with respect to the method 400, other methods of identifying the mode of travel may also be employed based on additional criteria or combinations of thereof.

At stage 416, the most likely mode of travel as identified at stage 414 is reported. The client device may thus be configured in accordance with the mode of travel. As described above, the travel mode data may incorporate a set of configuration settings associated with each mode of travel that are enabled in response to the travel mode determination performed by the method 400.

The stages of the illustrated methods described above are not intended to be limiting. The functionality of the methods may exist in a fewer or greater number of stages than what is shown and, even with the depicted methods, the particular order of events may be different from what is shown in the figures.

The systems and methods described herein advantageously provide for adaptive configuration of a client device based on an identified mode of travel. Particular modes of travel are associated with configuration settings that provide an optimal user experience when traveling in the identified manner. The methods and systems provide for a dynamic and reactive experience that alters the configuration of the client device as the user alters their method of travel based on criteria associated with each mode of travel.

As these and other variations and combinations of the features discussed above can be utilized without departing from the disclosure as defined by the claims, the foregoing description of the embodiments should be taken by way of illustration rather than by way of limitation of the disclosure as defined by the claims. It will also be understood that the provision of examples of the disclosure (as well as clauses phrased as “such as,” “e.g.”, “including” and the like) should not be interpreted as limiting the disclosure to the specific examples; rather, the examples are intended to illustrate only some of many possible embodiments.

1. A computer-implemented method for determining a mode of travel of a client device, the method comprising:
receiving sensor input from one or more sensors of the client device;
comparing, using a processor, the sensor input to a set of travel mode data, the travel mode data comprising a plurality of travel modes comprising a walking travel mode and a driving or bicycling travel mode, one or more criteria for at least one of the plurality of travel modes, and a set of configuration settings associated with the at the least one of the plurality of travel modes for providing location-based services using the client device;
selecting a likely travel mode from the set of travel mode data by matching the sensor input with the criteria for the at least one of the plurality of travel modes and identifying a travel mode that most highly correlates the criteria with the sensor input;
configuring the client device using the set of configuration settings associated with the selected likely travel mode,
wherein the set of configuration settings comprises display settings for automatically enabling display when the selected likely travel mode is the driving or bicycling travel mode, and for automatically disabling display when the selected likely travel mode is the walking travel mode and
wherein the sensor input comprises a geographic position of the client device as determined by a geographic positioning element;
identifying a type of route upon which the client device is traveling by comparing the geographic position with a set of map data,
wherein selecting the likely travel mode is based on comparing the identified type of route with the criteria for the at least one of the plurality of travel modes.

2-3. (canceled)

4. The method of claim 1, wherein the plurality of travel modes further comprise at least one of a an air travel mode and a mass transit travel mode.

5. The method of claim 1, wherein the client device is configured to perform route-finding operations.

6. The method of claim 5, wherein the route-finding operations identify a travel route via the likely travel mode.

7. The method of claim 1, wherein the one or more criteria for the at least one of the plurality of travel modes comprise a set of types of routes upon which the user has an option to travel when engaged in the travel mode.

8. The method of claim 7, wherein the walking travel mode is associated with at least one of a sidewalk, a crosswalk, and a walking path.

9. The method of claim 7, wherein the driving travel mode is associated with at least one of a city street, a county road, and a highway.

10. The method of claim 7, wherein a mass transit travel mode is associated with at least one of a subway, a bus route, and a train route.

11. The method of claim 10, wherein the one or more criteria for the mass transit travel mode comprise a velocity threshold associated with one or more mass transit stops.

12. The method of claim 1, further comprising:
identifying when the client device passes a transition point where a user has an option to transition from a first travel mode to a second travel mode; and
determining the travel mode of the client device in response to the client device passing the transition point.

13. The method of claim 12, wherein one or more transition points are defined in a set of map data.

14. The method of claim 13, wherein the set of map data is received from a remote server.

15. The method of claim 1, further comprising: sending the sensor input to a remote server; and sending the likely travel mode to the client device from the remote server.

16. A processing system for determining a mode of travel, the processing system comprising:
a processor;
one or more sensors coupled to the processor; and
a memory coupled to the processor for storing a set of travel mode data, the travel mode data comprising a plurality of travel modes comprising a walking travel mode and a driving travel mode, one or more criteria for at least one of the plurality of travel modes, and a set of configuration settings associated with the at least one of the plurality of travel modes for providing location-based services using the processing system;
the processor being configured to:
receive sensor input from the one or more sensors;
compare the sensor input to the one or more criteria;
select a likely mode of travel based on the comparison of the sensor input to the criteria;
configure the processing system using the set of configuration settings associated with the selected likely mode of travel,
wherein the set of configuration settings comprises navigation prompt settings for automatically enabling vibration prompts when the selected likely travel mode is the walking travel mode, and for automatically enabling audio prompts when the selected travel mode is the driving travel mode, and
wherein the sensor input comprises a geographic position of the processing system as determined by a geographic positioning element;
identify a type of route upon which the processing system is traveling by comparing the geographic position with a set of map data,
wherein selecting the likely travel mode is based on comparing the identified type of route with the criteria for the at least one of the plurality of travel modes.

17. The processing system of claim 16, wherein the memory further comprises the set of map data, which associates a plurality of locations with one or more types of routes.

18. The processing system of claim 17, wherein the one or more criteria specifies one or more types of routes that each travel mode may utilize.

19. The processing system of claim 18, wherein the processor is further configured to identify a location of the client device, and to filter the plurality of travel modes by the type of route upon which the client device is present.

20. A non-transitory computer readable storage medium containing instructions that, when executed by a processor, cause the processor to perform a method comprising:
receiving sensor input from one or more sensors;
comparing, using a processor, the sensor input to a set of travel mode data, the travel mode data comprising a plurality of travel modes comprising a walking or bicycling travel mode and a driving travel mode, one or more criteria for at least one of the plurality of travel modes, and a set of configuration settings associated with the at least one of the plurality of travel modes for providing location-based services using the client device;
selecting a likely travel mode from the set of travel mode data by matching the sensor input with the criteria from each travel mode and identifying a travel mode that best matches the criteria with the sensor input; and
configuring a client device using the set of configuration settings associated with the selected likely travel mode,
wherein the set of configuration settings comprises map detail settings for automatically providing additional map details when the selected likely travel mode is the walking or bicycling travel mode, relative to when the selected likely travel mode is the driving travel mode, and
wherein the sensor input comprises a geographic position of the client device as determined by a geographic positioning element;
identifying a type of route upon which the client device is traveling by comparing the geographic position with a set of map data,
wherein selecting the likely travel mode is based on comparing the identified type of route with the criteria for the at least one of the plurality of travel modes.

21-22. (canceled)

23. The non-transitory computer readable storage medium of claim 20, wherein the plurality of travel modes further comprise at least one of an air travel mode and a mass transit travel mode.

24. The method of claim 1, wherein the display settings comprise a sleep mode setting for disabling display based on the selected likely travel mode and an active display mode setting for enabling display based on the selected likely travel mode.

25. The method of claim 1, wherein the navigation prompt settings comprise a vibration mode setting for enabling the vibration prompts and an audio mode setting for enabling the audio prompts.

26. The method of claim 1, wherein the map detail settings comprise a first display mode setting for providing the additional map details and a second display mode setting so as not to provide the additional map details.
